(19) United States
(12) Patent Application Publication
(10) Pub. No.: US 2005/0108378 A1
(43) Pub. Date: May 19, 2005

(54) Instrumentation system and methods for estimation of decentralized network characteristics

(75) Inventors: James Patterson, Santa Clara, CA (US); Bruce Ward, Hot Springs, AR (US)

Correspondence Address: Patent Counsel, M/S 2061;Macrovision, Patent Department, Santa Clara, CA, 95050, US

(73) Assignee: MACROVISION CORPORATION, SANTA CLARA, CA (US)

(21) Appl. No.: 10/818,674

(22) Filed: Apr. 6, 2004

Related U.S. Application Data
(60) Provisional application No. 60/514,429, filed on Oct. 25, 2003.
(60) Provisional application No. 60/514,729, filed on Oct. 27, 2003.

(51) Int. Cl. G06F 15/173

(52) U.S. Cl. 709/223; 709/224

(57) ABSTRACT

An instrumentation system estimates characteristics of a decentralized network, such as: the size, growth rate, and growth acceleration of the network; the number of instances, the rate of propagation, and the acceleration of propagation of a file in the network; and the search and download activities, in the aggregate and for particular files, in the network. A data center in the instrumentation system performs a set of interrelated methods for inferring these and other characteristics of the network. For estimating some characteristics, it identifies and uses a subset of the network, and uses information from the subset to infer or obtain information of the entire network. For estimating other characteristics, it deploys software agents to masquerade as nodes in the network.

### CROSS REFERENCE TO RELATED APPLICATIONS

This application claims priority to U.S. provisional application Ser. No. 60/514,429 filed Oct. 25, 2003.

### FIELD OF THE INVENTION

The present invention generally relates to decentralized networks and in particular, to an instrumentation system and methods for estimation of decentralized network characteristics.

### BACKGROUND OF THE INVENTION

In a decentralized network, there is no central authority or managing entity. Nodes are not directly addressable or centrally observable. Instead, intelligence and control reside within the nodes themselves. Each node makes decisions autonomously to connect, disconnect, and share information with other nodes in the decentralized network according to a predetermined protocol established by the creators of the network.

In some networks, nodes decide autonomously to join or disjoin the network, causing the network to grow or shrink. Nodes are directly visible only to the immediate neighbors to which they are attached. As a result, especially for large networks with rich communications protocols, the size and topology of the overall decentralized network evolve continuously and organically, in a way that is largely uncontrollable and unpredictable from the perspective of any single node or external observer of the network.

With a network such as this, there is no authoritative source of information about the network. Further, there is no obvious means of determining the size, structure, or information contents of the network at any point in time. In some cases, the owner or creator of the network has no provision for tracking this information or making it available to outside parties. In other cases, the network might simply be too large or too dynamic to allow anyone to gather, aggregate and report this information to a single location.

### OBJECTS AND SUMMARY OF THE INVENTION

Accordingly, it is an object of the present invention to provide an instrumentation system and methods for estimating decentralized network characteristics.

Examples of such characteristics are: the size, growth rate, and growth acceleration of the decentralized network; the number of instances, the rate of propagation, and the acceleration of propagation of a file in the decentralized network; the aggregate search activity in the decentralized network; the search activity for a file in the decentralized network; and the download activity for a file in the decentralized network. In estimating these characteristics, it is useful to obtain a representative sample of nodes in the decentralized network, estimate the size of the decentralized network, uniformly infiltrate the decentralized network with software agents masquerading as nodes, and uniformly distribute files in the decentralized network.

This and additional objects are accomplished by the various aspects of the present invention, wherein briefly stated, one aspect is an instrumentation system for estimating decentralized network characteristics, comprising a computer configured to estimate the number of instances of a file in a decentralized network by identifying a representative sample of nodes in the decentralized network, determining the density of the file in the representative sample, and estimating the number of instances of the file in the decentralized network by multiplying the size of the network by the density of the file in the representative sample.

Another aspect is an instrumentation system for estimating decentralized network characteristics, comprising a computer configured to estimate a total number of search queries for a file in a decentralized network over a specified period of time by multiplying the total number of search queries for the file recorded over the specified period of time by software agents uniformly distributed in the decentralized network by the number of nodes in the decentralized network, and dividing the product by the number of software agents.

Another aspect is an instrumentation system for estimating decentralized network characteristics, comprising a computer configured to estimate a total number of downloads of a file in a decentralized network over a specified period of time by multiplying the total number of downloads of the file recorded over the specified period of time by software agents uniformly distributed in the decentralized network by the number of nodes in the decentralized network, and dividing the product by the number of software agents.

Another aspect is a method for identifying a representative sample of nodes in a decentralized network, comprising: indexing a sample of nodes in a decentralized network; building a set of observed values for one searchable attribute found in all nodes in the sample; drawing a sample of observed values for the one searchable attribute from the set; performing a search in the decentralized network for nodes having at least one of the observed values for the one searchable attribute as in the drawn sample; and generating a representative sample of nodes in the decentralized network by including at least a subset of nodes in the search results.

Another aspect is a method for identifying a representative sample of nodes in a decentralized network, comprising: (a) identifying a node in a decentralized network; (b) determining if the node has an attribute value matching an attribute value of a cell of an attribute matrix; (c) if the answer in (b) is NO, then jumping back to (a) to identify another node in the decentralized network, and if the answer to (b) is YES, then determining if the cell has reached its maximum number of associated nodes; (d) if the answer in (c) is NO, then associating the node to the cell and jumping back to (b) to determine if the node has another attribute value matching that of another cell of the attribute matrix, and if the answer in (c) is YES, then determining if all cells in the attribute matrix have reached their maximum numbers of associated nodes; and (e) if the answer in (d) is NO, then jumping back to (b) to determine whether the node has another attribute value matching that of another cell of the attribute matrix, and if the answer in (d) is YES, then generating a representative sample of nodes in the decentralized network from the nodes associated to the cells of the attribute matrix.

Another aspect is a method for estimating the number of nodes in a decentralized network, comprising: drawing a random sample of all potential addresses in an underlying address space common to a decentralized network and a reference network; counting the number of nodes associated with the decentralized network that reside at addresses in the random sample; calculating a density of the decentralized network nodes by dividing the count of nodes associated with the decentralized network by the number of addresses in the random sample; counting the number of nodes associated with a reference network that reside at addresses in the random sample; calculating a density of the reference network nodes by dividing the count of nodes associated with the reference network by the number of addresses in the random sample; and estimating the number of nodes in the decentralized network by multiplying the density of the decentralized network nodes with a known number of nodes in the reference network, and dividing the product by the density of the reference network nodes.

Another aspect is a method for estimating the number of nodes in a decentralized network, comprising: drawing a random sample of all potential addresses in an underlying address space; counting the number of nodes associated with the decentralized network that reside at addresses in the random sample; calculating a density of the decentralized network nodes by dividing the count of nodes associated with the decentralized network by the number of addresses in the random sample; and estimating the number of nodes in the decentralized network by multiplying the density of the decentralized network nodes by the size of the address space.

Another aspect is a method for estimating the growth rate of a decentralized network, comprising: estimating the number of nodes in the decentralized network at a point in time; estimating the number of nodes in the decentralized network at a fixed period of time after the point in time; and estimating the growth rate of the decentralized network by subtracting the estimated number of nodes in the decentralized network at the point in time from the estimated number of nodes in the decentralized network at the fixed period of time after the point in time, and dividing the difference by the fixed period of time.

Another aspect is a method for estimating acceleration in a growth of the number of nodes in a decentralized network, comprising: generating a first estimate of the number of nodes in the decentralized network at a time t0; generating a second estimate of the number of nodes in the decentralized network at a time (t0+Δt), where Δt is a time period; generating a third estimate of the number of nodes in the decentralized network at a time (t0+2·Δt), where 2·Δt is twice the time period; and estimating acceleration in the growth of the number of nodes in the decentralized network by generating a product by doubling the second estimate, generating a difference by subtracting the first and the third estimates from the product, and dividing the difference by the time period Δt.

Another aspect is a method for estimating the number of instances of a file in a decentralized network, comprising: identifying a representative sample of nodes in a decentralized network; determining a density of instances of a file in the representative sample of nodes; and estimating the number of instances of the file in the decentralized network by multiplying the density of instances of the file by the number of nodes in the decentralized network.

Another aspect is a method for estimating the rate of propagation of a file in a decentralized file network, comprising: estimating the number of instances of a file in a decentralized network at a point in time; estimating the number of instances of the file in the decentralized network at a fixed period of time after the point in time; and estimating the rate of propagation of the file in the decentralized network by generating a difference by subtracting the estimated number of instances of the file in the decentralized network at the point in time from the estimated number of instances of the file in the decentralized network at the fixed period of time after the point in time, and dividing the difference by the fixed period of time.

Another aspect is a method for estimating acceleration of the propagation of a file in a decentralized network, comprising: generating a first estimate of the rate of propagation of a file in a decentralized file network at a time t0; generating a second estimate of the rate of propagation of the file in the decentralized file network at a time (t0+Δt), where Δt is a time period; generating a third estimate of the rate of propagation of the file in the decentralized file network at a time (t0+2·Δt), where 2·Δt is twice the time period; and estimating acceleration of the propagation of the file in the decentralized network by generating a product by doubling the second estimate, generating a difference by subtracting the first and the third estimates from the second estimate, and dividing the difference by the time period Δt.

Another aspect is a method for uniformly infiltrating a decentralized network with software agents masquerading as nodes of the decentralized network, comprising: identifying a representative sample of nodes in a decentralized network; and attaching a corresponding software agent masquerading as a node to each of the nodes in the representative sample of nodes.

Another aspect is a method for uniformly distributing files in a decentralized network, comprising: uniformly infiltrating a decentralized network with software agents masquerading as nodes of the decentralized network; and uploading a file to each of the software agents.

Still another aspect is a method for estimating a total number of search queries in a decentralized network over a specified period of time, comprising: uniformly infiltrating a decentralized network with software agents masquerading as nodes in the decentralized network; causing the software agents to record all received search queries for a specified period of time; and estimating a total number of search queries in the decentralized network for the specified period of time by generating a sum by adding the received search queries recorded by the software agents during the specified period of time, generating a product by multiplying the sum by the number of nodes in the decentralized network, and dividing the product by the number of the software agents.

Another aspect is a method for estimating a total number of search queries for a file in a decentralized network over a specified period of time, comprising: uniformly infiltrating a decentralized network with software agents masquerading as nodes in the decentralized network; causing the software agents to record all received search queries for a file during a specified period of time; and estimating a total number of search queries for the file in the decentralized network for the specified period of time by generating a sum by adding the received search queries for the file recorded by the software agents during the specified period of time, generating a product by multiplying the sum by the number of nodes in the decentralized network, and dividing the product by the number of the software agents.

Yet another aspect is a method for estimating a total number of downloads of a file in a decentralized network over a specified period of time, comprising: uniformly infiltrating a decentralized network with software agents masquerading as nodes in the decentralized network; uploading copies of a file to each of the software agents; causing the software agents to respond to each request to download a copy of the file over a specified period of time, and keep a record of each download; determining the aggregate number of downloads of copies of the file over the specified period of time by all the software agents; and estimating a total number of downloads of the file in the decentralized network over the specified period of time by generating a product by multiplying the aggregate number of downloads of copies of the file over the specified period of time by all the software agents by the estimated number of nodes in the decentralized network, and dividing the product by the number of software agents.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of an instrumentation system utilizing aspects of the present invention.

FIG. 2 illustrates a flow diagram of a method for identifying a representative sample of nodes in a decentralized network, utilizing aspects of the present invention.

FIG. 3 illustrates a flow diagram of an alternative method for identifying a representative sample of nodes in a decentralized network, utilizing aspects of the present invention.

FIG. 4 illustrates a flow diagram of a method for estimating the number of nodes in a decentralized network, utilizing aspects of the present invention.

FIG. 5 illustrates a flow diagram of an alternative method for estimating the number of nodes in a decentralized network, utilizing aspects of the present invention.

FIG. 6 illustrates a flow diagram of a method for estimating the growth rate of a decentralized network, utilizing aspects of the present invention.

FIG. 7 illustrates a flow diagram of a method for estimating acceleration in the growth of a decentralized network, utilizing aspects of the present invention.

FIG. 8 illustrates a flow diagram of a method for estimating the number of instances of a file in a decentralized network, utilizing aspects of the present invention.

FIG. 9 illustrates a flow diagram of a method for estimating the rate of propagation of a file in a decentralized network, utilizing aspects of the present invention.

FIG. 10 illustrates a flow diagram of a method for estimating acceleration of the propagation of a file in a decentralized network, utilizing aspects of the present invention.

FIG. 11 illustrates a flow diagram of a method for uniformly infiltrating a decentralized network with software agents masquerading as nodes of the decentralized network, utilizing aspects of the present invention.

FIG. 12 illustrates a flow diagram of a method for uniformly distributing files in a decentralized network, utilizing aspects of the present invention.

FIG. 13 illustrates a flow diagram of a method for estimating a total number of search queries in a decentralized network over a specified period of time, utilizing aspects of the present invention.

FIG. 14 illustrates a flow diagram of a method for estimating a total number of search queries for a file in a decentralized network over a specified period of time, utilizing aspects of the present invention.

FIG. 15 illustrates a flow diagram of a method for estimating a total number of downloads of a file in a decentralized network over a specified period of time, utilizing aspects of the present invention.

### DETAILED DESCRIPTION OF THE PREFERRED EMBODIMENT

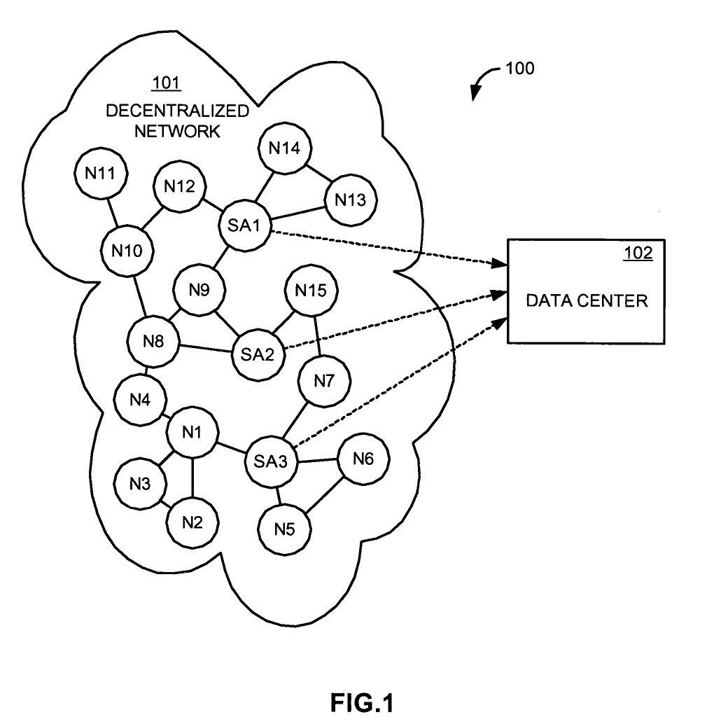

FIG. 1 illustrates a block diagram of an Instrumentation System 100 for estimating characteristics of a Decentralized Network 101, such as: the size, growth rate, and growth acceleration of the Decentralized Network 101; the number of instances, the rate of propagation, and the acceleration of propagation of a file in the Decentralized Network 101; and the search and download activities, in the aggregate and for particular files, in the Decentralized Network 101.

The term “file” as used herein means a file or object as those terms are conventionally understood, such as or as well as, a document, message, computer program, data, all forms of media (such as audio, video, animation, and images), and any other content or information protected under copyright or any other intellectual property law that is capable of being communicated between two nodes of a network.

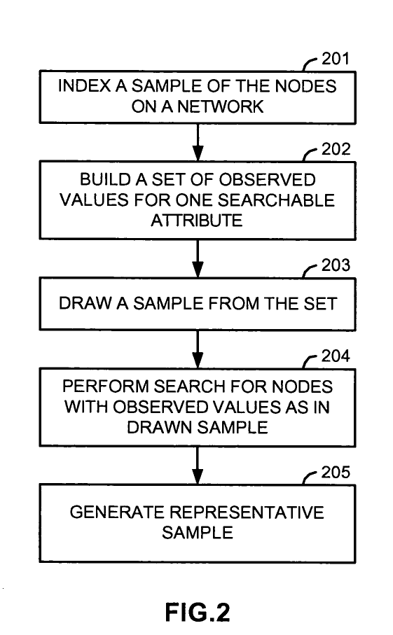

A Data Center 102 performs a set of interrelated methods, described in reference to FIGS. 2˜15, for inferring these and other characteristics of the entire Decentralized Network 101. For estimating some characteristics, it identifies and uses a subset (such as N1, N2, N3 and N4) of the Network 101, and uses information from the subset to infer or obtain information of the entire Decentralized Network 101. For estimating other characteristics, it deploys Software Agents such as SA1, SA2 and SA3 to masquerade as nodes in the Decentralized Network 101.

The Data Center 102 consists of one or more computers configured through software to perform the interrelated methods. The Software Agents are implemented as software residing on either the Data Center 102 or on one or more other computers. In either case the Software Agents communicate with nodes in the Decentralized Network 604 through individually assigned ports of the computers on which they reside. IP addresses for the ports may vary with time or in some other manner so that detection of the Software Agents as unauthorized masqueraders of nodes in the Decentralized Network 101 is made difficult. When the Software Agents reside on one or more computers other than the Data Center 102, those computers communicate with and their activities are coordinated by the Data Center 102 through, for examples, a local area network, wide area network, or virtual network.

Following is a brief road map of the methods used by the Data Center 102 in estimating various characteristics of the Decentralized Network 101. To better appreciate these methods, it is noted that the estimations are intrinsically difficult to make, because the nodes of the decentralized network are not centrally, directly, or randomly addressable, or observable from any central location. The decentralized network may also be too large or too dynamic to crawl exhaustively. For example, by the time 1% of the network has been crawled, the network may have already trebled in size and organically developed a fundamentally different topology. In addition, many of the previously visited nodes may no longer be in the network. The following methods therefore overcome these and other difficulties intrinsic to decentralized networks.

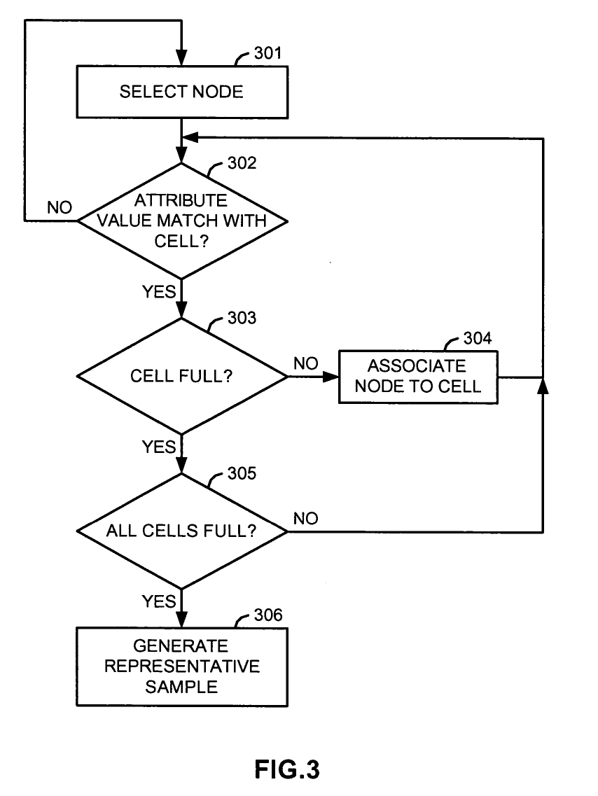

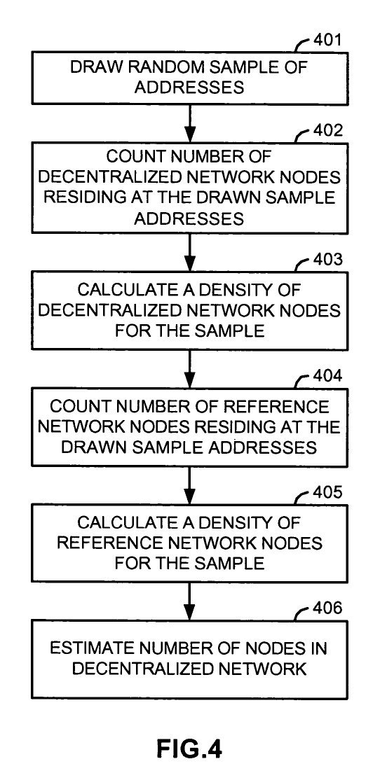

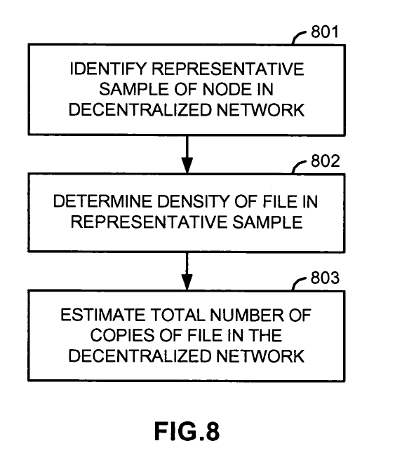

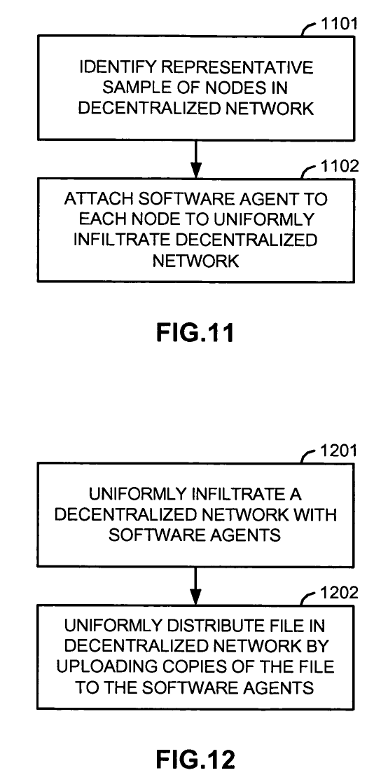

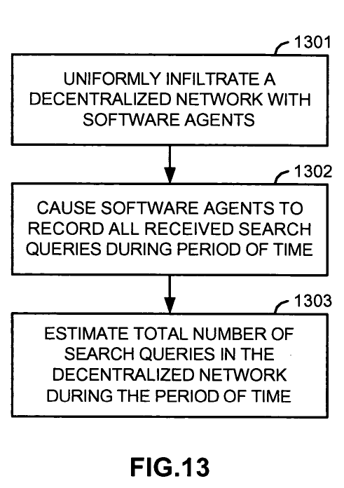

Methods described in reference to FIGS. 2 and 3 are alternative techniques for obtaining a representative sample of nodes in the Decentralized Network 101. The representative sample is then used in other methods in estimating various characteristics of the Decentralized Network 101. Methods described in reference to FIGS. 4-7, which build upon the methods of FIGS. 2 and 3, are techniques for estimating the total number of nodes in the Decentralized Network 101 (i.e., the size of the network), and the pace at which the number is changing (i.e., the growth rate and growth acceleration). Methods described in reference to FIGS. 8-10, which build upon the aforementioned methods, are techniques for estimating the total number of instances of a specified file or document stored on nodes throughout the network, and the rate at which that number is changing. Methods described in reference to FIGS. 11 and 12 are respectively techniques for infiltrating software agents masquerading as nodes uniformly throughout the Decentralized Network 101, and implanting files or documents uniformly throughout the Decentralized Network 101. Methods described in reference to FIGS. 13˜15, which build upon the methods described in reference to FIGS. 11 and 12, are respectively techniques for estimating overall file search activity, specific file search activity, and file or document download activity.

Now commencing a more detailed description of the methods, FIG. 2 illustrates a flow diagram of a method for identifying a representative sample of nodes in the Decentralized Network 101. To truly be “representative”, the representative sample of nodes should be unbiased by network topology or geographical location, and they should be uniformly distributed across the Decentralized Network 101.

In 201, the method indexes a sample of nodes in the Decentralized Network 101. The sample of nodes is generated, for example, by identifying a node (such as N1) in the Network 101 and using it to iteratively identify other nodes which are connected directly (such as N2, N3 and N4) or indirectly (such as N8, N9, N10, N11, and N12) to the identified node. For convenience, the identified node may be a node (such as N1) that is directly connected to a node that the Data Center 102 connects to the Network 101 (such as Software Agent SA3). Because of the closely connected relationship of the nodes, the sample of nodes in this case is expected to have some bias with likely topological or geographic skew.

In 202, the method builds a set or corpus of observed values for one searchable attribute that is found in all nodes in the sample of nodes obtained in 201. The searchable attribute is preferably chosen so that it is not highly correlated to (i.e., remains independent of) network topology. Since geographical location is often related to network topology (i.e., directly connected or linked nodes are generally geographically close to one another), selection of a searchable attribute that is independent of network topology generally requires that it also be independent of geographical location. Examples include: observed file name or document title phrases; observed words, letters, or syllables within file names or document titles; observed words, letters, or syllables within file or document descriptions; and mathematical hash values of any of the above. Still other examples include numerical attributes such as: file size in bytes; media length in time; and message size in number of characters.

In 203, the method then draws a sample of observed values for the one searchable attribute from the set of observed values built in 202.

In 204, the method performs a search in the Decentralized Network 101 for nodes having at least one of the observed values in the sample that was drawn in 203. It is particularly interesting that these nodes will be distributed randomly and uniformly across the Decentralized Network 101, unlike the original sample indexed in 201. Therefore, they provide an unbiased estimate of the value and/or distribution of their nodal attributes.

In 205, the method then generates the representative sample of nodes in the Decentralized Network 101 by including at least a subset of the nodes in the search results of 204. The subset may be all of the nodes in the search result, or a randomly selected subset if the number of nodes in the search result is too large for convenient handling and efficient processing to obtain an unbiased estimate of the distribution of other node attributes (i.e., other than the one searchable attribute used in 202).

FIG. 3 illustrates a flow diagram of an alternative method for identifying a representative sample of nodes in a decentralized network. The method utilizes an attribute matrix, which includes primary nodal attributes for which the representative sample must be representative. Examples of such primal nodal attributes in general include: topological network location, physical geographic location, client software application and/or version number, tenure of network membership, speed of network connectivity, and unique numerical address (e.g., IP address). In a decentralized network, the primal nodal attributes may also include: number of files residing on the node, the type of files residing on the node (e.g., music, video, software, image, text document), and the number of files or documents of a specific title residing on the node.

After selecting the primal nodal attributes, the attribute matrix is then generated so as to represent all possible combinations of values for the selected attributes. For example, if a given application suggests that physical location (with four levels) and speed of connectivity (with two levels) are the critical attributes, then the following 2×4 attribute matrix results:

| | East Coast | West Coast | Midwest | South |
|---|---|---|---|---|
| ≦300 kbps | | | | |
| >300 kbps | | | | |

For more complicated applications, multi-dimensional attribute matrices may result.

As part of defining the attribute matrix, it is necessary to also determine an overall sample size to be used in the method, and a maximum number to be associated to each cell of the attribute matrix. In one approach, the maximum number may be the same for each cell with a value for each node associated with the cell according to the method weighted by a known percentage at which the combination of attribute values corresponding to the cell appears in the population of interest. When the sum of the values for all nodes associated with a cell reaches the maximum number, the cell is determined at that point to be “full”. For example, assuming an overall sample size of 8,000, then the maximum number for each cell would be 1000 (i.e., 8,000/[2×4]). The value of each associated node to the upper left-most cell in the matrix above would be weighted by, for example, the fraction of all U.S. narrowband Internet users who reside on the East Coast and are known to use the Decentralized Network 101.

In another approach, the maximum number would be determined by the known percentage at which the combination of attribute values corresponding to the cell appears in the population of interest. For example, if the percentages of East Coast, West Coast, Midwest and South U.S. narrowband Internet users who use the Decentralized Network 101 to all U.S. narrowband Internet users are respectively 30%, 30%, 20% and 20%; the percentages of East Coast, West Coast, Midwest and South U.S. broadband Internet users who use the Decentralized Network 101 to all U.S. broadband Internet users are respectively 35%, 30%, 20% and 15%; and the percentage of U.S. narrowband and U.S. broadband Internet users to all U.S. Internet users are respectively 50% and 50%; then the maximum number of nodes associated with each cell would be as follows:

| | East Coast | West Coast | Midwest | South |
|---|---|---|---|---|
| ≦300 kbps | 1,200 | 1,200 | 800 | 800 |
| >300 kbps | 1,400 | 1,200 | 800 | 600 |

The resulting attribute matrix is then processed according to the method described in reference to FIG. 3. In 301, the method identifies a starting node in the Decentralized Network 101. For convenience, the identified node may be a node (such as N1) that is directly connected to a node that the Data Center 102 connects to the Network 101 (such as Software Agent SA3).

In 302, the method determines if the node identified in 301 has an attribute value that matches that of one of the cells of the attribute matrix. If the answer in 302 is NO (i.e., there is no match), then the method jumps back to 301 to identify another node by, for example, crawling the network topology in a conventional fashion starting with the starting node. On the other hand, if the answer in 302 is YES (i.e., there is a match), then the method proceeds to 303.

In 303, the method determines if the maximum number for that cell has been reached (i.e., the cell is considered “full” since no more nodes are to be associated with that cell), wherein the maximum number was previously described above in reference to building the attribute matrix. If the answer in 303 is NO, then in 304, the matched node is associated to the cell, and the method jumps back to 302 to see if the node has another attribute value that matches that of another cell in the attribute matrix. If the answer in 303 is YES, however, then the method proceeds to 305.

In 305, the method determines if the maximum numbers for all cells in the attribute matrix have been reached. If the answer in 305 is NO, then the method jumps back to 302 to see if the node has another attribute value that matches that of another cell in the attribute matrix. On the other hand, if the answer in 305 is YES, then in 306, the method generates the representative sample of nodes in the Decentralized Network 101 from the nodes associated to the cells of the attribute matrix. In this case, all such nodes would preferably be included in the representative sample, since the overall sample size selected when defining the attribute matrix should ensure that the number of nodes in the representative sample is not too large for convenient handling and efficient processing.

FIG. 4 illustrates a flow diagram of a method for estimating the number of nodes in a Decentralized Network 101. This method utilizes a reference network with a known number of nodes and having the same underlying address space as the Decentralized Network 101 for defining IP addresses. The reference network may be another decentralized network that keeps track of and publishes the number of nodes connected to it at the time.

In 401, the method draws a random sample of addresses from all potential addresses in an underlying address space that is common to the Decentralized Network 101 and the reference network.

In 402, the method counts the number of nodes associated with the Decentralized Network 101 that are operating at addresses in the random sample of addresses. One technique for performing this function is a Low-Level Port Scan Approach. In this approach, a list of ports or sockets known to be used by the client software application for the Decentralized Network 101 is built for each IP address in the range. This is feasible, because typically any given client software application uses a standard port or range of ports. Then, for each port or socket in the list, an attempt is made to establish a low-level IP-network connection via that port (e.g., open a TCP session, issue HTTP GET command, or issue ICMP Ping, etc.). If the port responds with a legitimate IP-network message, infer that the port is active and infer from the port number, the identity of the client software application that is likely to be in use (i.e., is it for the Decentralized Network 101, or for another type of decentralized network). Furthermore, if the port responds with a legitimate HTTP message header or User Agent that self-describes the product and version number of the client software application, then infer the identify of the client software application that is likely to be in use. On the other hand, if the port does not respond, responds with gibberish, or responds with an illegitimate IP-network message, conclude that the port is inactive and move on to the port or socket in the list. This approach not only reveals the IP addresses hosting the client software application for the Decentralized Network 101, but also the IP addresses hosting other client software applications corresponding to other types or versions of decentralized networks. Using this information, the density for each type of client software application (e.g., AOL instant messenger, ICQ, GNUtella, etc.) can be determined. In particular, with a sufficiently large representative sample of IP addresses, it is possible to draw conclusions about the absolute density of each client software application across all IP addresses and the relative size of the decentralized networks associated with each client software application.

Another technique for performing the function of 402 is a High-Level Application Scan Approach. In this approach, a list of ports or sockets known to be used by the client software application for the Decentralized Network 101 is again built for each IP address in the range. Then, for each port or socket in the list, an attempt is made to establish a high-level peer-to-peer-network-specific connection via the port for the client software application of interest (e.g., request a file transfer for an IRC client software application, send an instant message in AOL instant messenger, etc.). If the port responds with a legitimate, high-level message from the peer application itself (rather than from the lower level transport mechanism), even if the message is denying a connection, conclude that the client software application of the assumed type is running on the port. This procedure can be repeated for other client software applications to draw conclusions about the densities of each of the assumed client software applications across representative sample of IP addresses. As a variation of this approach, rather than building a list of ports known to be used by client software applications of interest, all 65535 defined ports may be scanned. Although this variation takes longer, it has the benefit of finding instances of client software applications operating through unconventional or unanticipated sockets.

Yet another technique for performing the function of 402 is a Honey Pot Approach. In this approach, information for several different types of decentralized networks is obtained. For each type of network, one or more client nodes are controlled by the Data Center 102 and connected to the network, such as Software Agent SA1. On each of these client nodes, one or more highly desirable files or documents, or decoys thereof, are hosted. If required or supported by the decentralized network type, the availability of these items is announced to the network. The IP addresses of all nodes attempting to communicate or connect with the client nodes during a fixed period time are recorded. Based upon the number of unique IP addresses recorded for each type of decentralized network, the relative sizes of the networks can be inferred. For networks that support multiple client software applications (e.g., AOL Instant Messenger 1.0 and AOL Instant Messenger 2.0), the relative installed base or usage of each client software application is inferred.

In 403, the method calculates a density of the nodes of the Decentralized Network 101 by dividing the count generated in 402 by the number of addresses in the random sample of addresses drawn in 401.

In 404, the method counts the number of nodes associated with the reference network that reside at addresses in the random sample of addresses, in essentially the same manner as described in reference to 402, and in 405, the method calculates a density of the nodes of the reference network by dividing the count generated in 404 by the number of addresses in the random sample of addresses drawn in 401.

In 406, the method estimates the number of nodes in the Decentralized Network 101 by multiplying the density of the nodes of the Decentralized Network 101 calculated in 403 with the known number of nodes in the reference network, and dividing the product by the density of the nodes of the reference network calculated in 405.

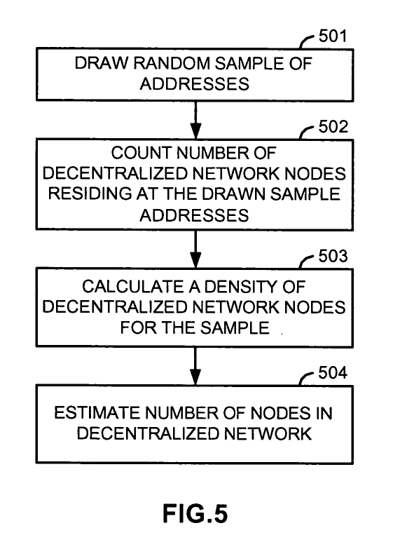

FIG. 5 illustrates a flow diagram of an alternative method for estimating the number of nodes in a decentralized network. In 501, the method draws a random sample of addresses from all potential addresses in an underlying address space of the Decentralized Network 101. In 502, the method counts the number of nodes associated with the Decentralized Network 101 that reside at addresses in the random sample of addresses, in essentially the same manner as described in reference to 402 of FIG. 4, and in 503, the method calculates a density of the nodes of the Decentralized Network 101 by dividing the count generated in 502 by the number of addresses in the random sample of addresses drawn in 501. In 504, the method then estimates the number of nodes in the Decentralized Network 101 by multiplying the density calculated in 503 by the known size of the underlying address space.

As an example of this method, suppose a network of peer-to-peer instant messaging clients is running atop IPv4, which has a total address space of about 4 billion (i.e., 2³²) unique IP addresses. In this case, if a sample size of 1,000 IP addresses is desired, then 1,000 numbers are randomly drawn between 1 and 2³², wherein each of these numbers corresponds to a unique IP address. By port scanning or by attempting to connect to each of IP addresses, the IP addresses connected to the Decentralized Network 101 and the nodes residing at those addresses can be determined. For example, if 3 of the addresses had single nodes connected to the Decentralized Network 101, and 1 additional address referenced a private address space with 4 additional nodes connected to the Decentralized Network 101, then the total number of nodes in the Decentralized Network 101 is estimated to be approximately 30 million clients (i.e., 2³²·[(3+4)/1000]).

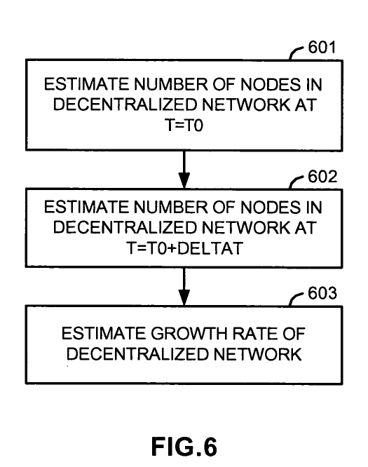

FIG. 6 illustrates a flow diagram of a method for estimating the growth rate of a decentralized network. In 601, the method estimates the number of nodes in the Decentralized Network 101 at a time t0. In 602, the method waits for a fixed period of time DELTAT (or Δt), and then estimates again the number of nodes in the Decentralized Network 101 at a time (t0+Δt).

In 603, the method then estimates the growth rate of the Decentralized Network 101 by subtracting the estimated number of nodes in the Decentralized Network 101 at the time t0 from the estimated number of nodes in the Decentralized Network 101 at the time (t0+Δt), and dividing the difference by the fixed period of time Δt. Estimation of the number of nodes in the Decentralized Network 101, as performed in 601 and 602, may be performed by following either the method described in reference to FIG. 4 or that of FIG. 5.

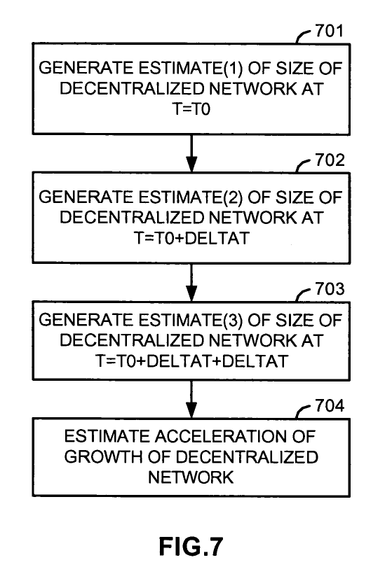

FIG. 7 illustrates a flow diagram of a method for estimating acceleration in the growth of a decentralized network. In 701, the method generates a first estimate (E1) of the number of nodes in the Decentralized Network 101 at a time t0. In 702, the method waits for a period of time (Δt), and then generates a second estimate (E2) of the number of nodes in the Decentralized Network 101 at a time (t0+Δt). In 703, the method once again waits for the period of time (Δt), and then generates a third estimate (E3) of the number of nodes in the Decentralized Network 101 at a time (t0+2·Δt).

In 704, the method then estimates the acceleration in growth of the number of nodes in the Decentralized Network 101 by generating a product by doubling the second estimate (i.e., [2·E2]), generating a difference by subtracting the first and the third estimates from the product (i.e., [2·E2]−E1−E3), and dividing the difference by the time period Δt (i.e., [[2·E2]−E1−E3]/Δt). Generation of the first, the second, and the third estimates may be performed by following either the method described in reference to FIG. 4 or that of FIG. 5.

FIG. 8 illustrates a flow diagram of a method for estimating the number of instances of a file in a decentralized network. In 801, the method identifies a representative sample of nodes in the Decentralized Network 101 by performing either the method described in reference to FIG. 2 or that of FIG. 3.

In 802, the method determines the density of instances of a file in the representative sample of nodes identified in 801. One way that it does this is by counting the number of instances of the file residing on the representative sample of nodes; and dividing the count by the number of nodes in the representative sample of nodes. Another way is determining a globally unique identifier for the file by, for example, querying the Decentralized Network 101 for the file and obtaining the globally unique identifier from the search results; counting the number of occurrences of the globally unique identifier among all nodes of the representative sample of nodes; and dividing the count by the number of nodes in the representative sample of nodes. Yet another way is computing one-way hash values for all files residing on the representative sample of nodes; counting the number of times that a one-way hash value for the file occurs among the computed one-way hash values for all files residing on the representative sample of nodes; and dividing the count by the number of nodes in the representative sample of nodes.

In 803, the method estimates the number of instances of the file in the Decentralized Network 101 by multiplying the density of its nodes as determined in 802 with the total number of nodes in Decentralized Network 101. If information of the total number of nodes in the Decentralized Network 101 is not available, then this number is estimated using, for example, one of the methods described in reference to FIGS. 4 and 5.

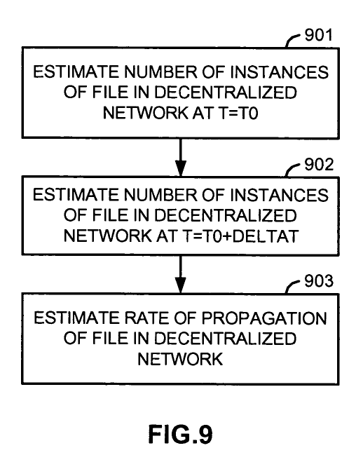

FIG. 9 illustrates a flow diagram of a method for estimating the rate of propagation of a file in a decentralized network. In 901, the method estimates the number of instances of the file in the Decentralized Network 101 at a time t0, using, for example, the method described in reference to FIG. 8. In 902, the method waits for a fixed period of time DELTAT (or Δt), and then estimates again the number of instances of the file in the Decentralized Network 101 at a time (t0+Δt).

In 903, the method then estimates the rate of propagation of the file in the Decentralized Network 101 by subtracting the estimated number of instances in the Decentralized Network 101 at the time t0 from the estimated number of instances in the Decentralized Network 101 at the time (t0+Δt), and dividing the difference by the fixed period of time Δt.

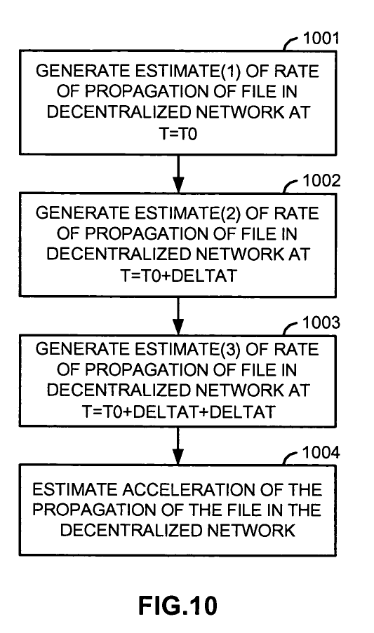

FIG. 10 illustrates a flow diagram of a method for estimating acceleration of the propagation of a file in a decentralized network. In 1001, the method generates a first estimate (E1) of the number of the rate of propagation of the file in the Decentralized Network 101 at a time t0. In 1002, the method waits for a period of time (Δt), and then generates a second estimate (E2) of the rate of propagation of the file in the Decentralized Network 101 at a time (t0+Δt). In 1003, the method once again waits for the period of time (Δt), and then generates a third estimate (E3) of the rate of propagation of the file in the Decentralized Network 101 at a time (t+2·Δt).

In 1004, the method then estimates the acceleration of propagation of the file in the Decentralized Network 101 by generating a product by doubling the second estimate (i.e., [2·E2]), generating a difference by subtracting the first and the third estimates from the product (i.e., [2·E2]−E1−E3), and dividing the difference by the time period Δt (i.e., [[2·E2]−E1−E3]/At). Generation of the first, the second, and the third estimates may be performed, for example, by following the method described in reference to FIG. 9.

FIG. 11 illustrates a flow diagram of a method for uniformly infiltrating a decentralized network with software agents masquerading as nodes of the decentralized network. In 1101, the method identifies a representative sample of nodes in the Decentralized Network 101 by performing either the method described in reference to FIG. 2 or that of FIG. 3. In 1102, the method then attaches a corresponding Software Agent masquerading as node to each of the nodes in the representative sample of nodes. As previously described, the Software Agents are software agents that either reside on one or more computers making up the Data Center 102, or on one or more computers connected to the Data Center 102 directly or through a virtual network. In any event, their activities are generally managed and/or defined by the Data Center 102.

FIG. 12 illustrates a flow diagram of a method for uniformly distributing files in a decentralized network. In 1201, the method uniformly infiltrates the Decentralized Network 101 with Software Agents masquerading as nodes of the Decentralized Network 101 in the same manner, for example, as described in reference to FIG. 11. In 1202, the method then uploads a file to each of the Software Agents.

FIG. 13 illustrates a flow diagram of a method for estimating a total number of search queries in a decentralized network over a specified period of time. In 1301, the method uniformly infiltrates the Decentralized Network 101 with Software Agents in the same manner, for example, as described in reference to FIG. 11. In 1302, the method causes the Software Agents to record all search queries that they receive over a specified period of time.

In 1303, the method then estimates the total number of search queries in the Decentralized Network 101 for the specified period of time by generating a sum by adding the received search queries recorded by the Software Agents during the specified period of time, generating a product by multiplying the sum by the number of nodes in the Decentralized Network 101, and dividing the product by the number of the Software Agents. If information of the total number of nodes in the Decentralized Network 101 is not available, then this number is estimated using, for example, one of the methods described in reference to FIGS. 4 and 5.

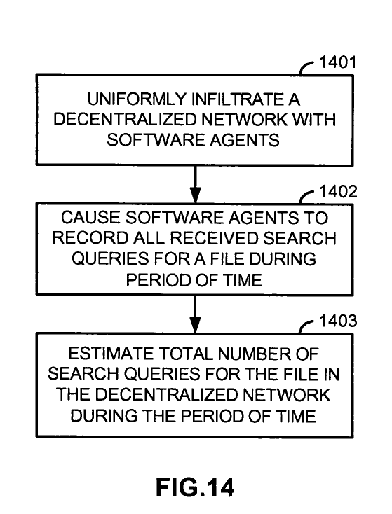

FIG. 14 illustrates a flow diagram of a method for estimating a total number of search queries for a file in a decentralized network over a specified period of time. In 1401, the method uniformly infiltrates the Decentralized Network 101 with Software Agents in the same manner, for example, as described in reference to FIG. 11. In 1402, the method causes the Software Agents to record all search queries for a file that they receive over a specified period of time.

In 1403, the method then estimates the total number of search queries for the file in the Decentralized Network 101 for the specified period of time by generating a sum by adding the received search queries for the file recorded by the Software Agents during the specified period of time, generating a product by multiplying the sum by the number of nodes in the Decentralized Network 101, and dividing the product by the number of the Software Agents. If information of the total number of nodes in the Decentralized Network 101 is not available, then this number is estimated using, for example, one of the methods described in reference to FIGS. 4 and 5.

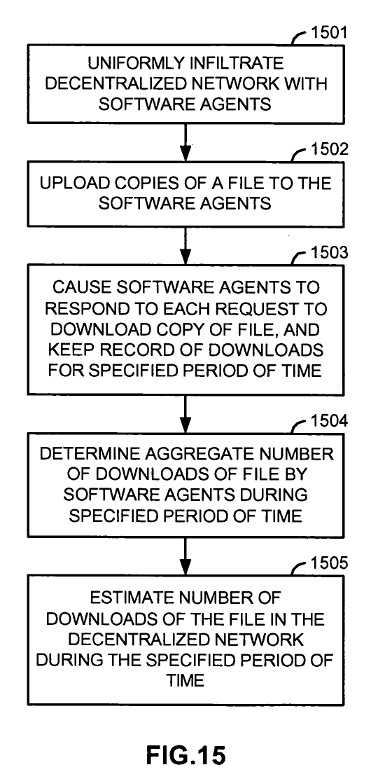

FIG. 15 illustrates a flow diagram of a method for estimating a total number of downloads of a file in a decentralized network over a specified period of time. In 1501, the method uniformly infiltrates the Decentralized Network 101 with Software Agents in the same manner, for example, as described in reference to FIG. 11. In 1502, the method then uploads a file to each of the Software Agents. The files in this case may be legitimate copies or decoys designed to masquerade as or otherwise spoof legitimate copies.

In 1503, the method causes the Software Agents to respond to each request to download a copy of the file in accordance with the policies and traditions of the Decentralized Network 101 over a specified period of time (e.g., one minute, one hour, one day, etc.), and keep a record of each download by retaining a log of all events. In 1504, the method then determines the aggregate number of successful downloads for all the Software Agents over the specified period of time from their respective records of downloads.

In 1505, the method then estimates the total number of downloads of the file in the Decentralized Network 101 over the specified period time by generating a product by multiplying the aggregate number of downloads determined in 1504 over the specified time period, and dividing the product by the number of Software Agents.

Although the various aspects of the present invention have been described with respect to a preferred embodiment, it will be understood that the invention is entitled to full protection within the full scope of the appended claims.

1. An instrumentation system for estimating decentralized network characteristics, comprising a computer configured to estimate the number of instances of a file in a decentralized network by identifying a representative sample of nodes in the decentralized network, determining the density of the file in the representative sample, and estimating the number of instances of the file in the decentralized network by multiplying the size of the network by the density of the file in the representative sample.

2. The instrumentation system according to claim 1, wherein the computer is configured to identify the representative sample of nodes in the decentralized network by indexing a sample of nodes in the decentralized network; building a set of observed values for one searchable attribute found in all nodes in the sample; drawing a sample of observed values for the one searchable attribute from the set; performing a search in the decentralized network for nodes having at least one of the observed values for the one searchable attribute; and generating the representative sample of nodes by including at least a subset of nodes in the search results.

3. The instrumentation system according to claim 2, wherein the one searchable attribute is independent of network topology.

4. The instrumentation system according to claim 3, wherein the computer is further configured to index the sample of nodes in the decentralized network by identifying a node in the decentralized network, and identifying other nodes connected directly or indirectly to the identified node.

5. The instrumentation system according to claim 1, wherein the computer is configured to identify the representative sample of nodes in the decentralized network by associating nodes in the decentralized network to cells of an attribute matrix having matching attribute values until maximum numbers of nodes are associated to all cells of the attribute matrix so that the representative sample of nodes is generated from at least a subset of the nodes associated to the cells of the attribute matrix.

6. The instrumentation system according to claim 5, wherein the attributes of the attribute matrix are key attributes for which the representative sample of nodes is to be representative.

7. The instrumentation system according to claim 5, wherein the maximum number of nodes associated to each cell is based upon an estimated percentage of nodes in the decentralized network having the attribute value of the cell.

8. The instrumentation system according to claim 5, wherein nodes selected for associating with the cells of the attribute matrix are selected by crawling the network topology starting from an initially selected node.

9. The instrumentation system according to claim 1, wherein the computer is further configured to estimate the rate of propagation of the file in the decentralized network by estimating the number of instances of the file at two points in time, and dividing a difference between the two estimates by a time period between the two points in time.

10. The instrumentation system according to claim 1, wherein the computer is further configured to estimate acceleration of propagation of the file in the decentralized network by estimating the number of instances of the file at three points in time.

11. An instrumentation system for estimating decentralized network characteristics, comprising a computer configured to estimate a total number of search queries for a file in a decentralized network over a specified period of time by multiplying the total number of search queries for the file recorded over the specified period of time by software agents uniformly distributed in the decentralized network by the number of nodes in the decentralized network, and dividing the product by the number of software agents.

12. The instrumentation system according to claim 11, wherein the computer is further configured to uniformly distribute the software agents in the decentralized network by identifying a representative sample of nodes in the decentralized network, and attaching a corresponding software agent to each of the nodes in the representative sample of nodes.

13. The instrumentation system according to claim 12, wherein the computer is configured to identify the representative sample of nodes in the decentralized network by indexing a sample of nodes in the decentralized network; building a set of observed values for one searchable attribute found in all nodes in the sample; drawing a sample of observed values for the one searchable attribute from the set; performing a search in the decentralized network for nodes having at least one of the observed values for the one searchable attribute; and generating the representative sample of nodes by including at least a subset of nodes in the search results.

14. The instrumentation system according to claim 13, wherein the one searchable attribute is independent of network topology.

15. The instrumentation system according to claim 14, wherein the computer is further configured to index the sample of nodes in the decentralized network by identifying a node in the decentralized network, and identifying other nodes connected directly or indirectly to the identified node.

16. The instrumentation system according to claim 13, wherein the computer is configured to identify the representative sample of nodes in the decentralized network by associating nodes in the decentralized network to cells of an attribute matrix having matching attribute values until maximum numbers of nodes are associated to all cells of the attribute matrix so that the representative sample of nodes is generated from at least a subset of the nodes associated to the cells of the attribute matrix.

17. The instrumentation system according to claim 16, wherein the attributes of the attribute matrix are key attributes for which the representative sample of nodes is to be representative.

18. The instrumentation system according to claim 16, wherein the maximum number of nodes associated to each cell is based upon an estimated percentage of nodes in the decentralized network having the attribute value of the cell.

19. The instrumentation system according to claim 16, wherein nodes selected for associating with the cells of the attribute matrix are selected by crawling the network topology starting from an initially selected node.

20. An instrumentation system for estimating decentralized network characteristics, comprising a computer configured to estimate a total number of downloads of a file in a decentralized network over a specified period of time by multiplying the total number of downloads of the file recorded over the specified period of time by software agents uniformly distributed in the decentralized network by the number of nodes in the decentralized network, and dividing the product by the number of software agents.

21. The instrumentation system according to claim 20, wherein the computer is further configured to uniformly distribute the software agents in the decentralized network by identifying a representative sample of nodes in the decentralized network, and attaching a corresponding software agent to each of the nodes in the representative sample of nodes.

22. The instrumentation system according to claim 21, wherein the computer is configured to identify the representative sample of nodes in the decentralized network by indexing a sample of nodes in the decentralized network; building a set of observed values for one searchable attribute found in all nodes in the sample; drawing a sample of observed values for the one searchable attribute from the set; performing a search in the decentralized network for nodes having at least one of the observed values for the one searchable attribute; and generating the representative sample of nodes by including at least a subset of nodes in the search results.

23. The instrumentation system according to claim 22, wherein the one searchable attribute is independent of network topology.

24. The instrumentation system according to claim 23, wherein the computer is further configured to index the sample of nodes in the decentralized network by identifying a node in the decentralized network, and identifying other nodes connected directly and indirectly to the identified node until a statistically representative sample of nodes is included in the sample of nodes being indexed.

25. The instrumentation system according to claim 22, wherein the computer is configured to identify the representative sample of nodes in the decentralized network by associating nodes in the decentralized network to cells of an attribute matrix having matching attribute values until maximum numbers of nodes are associated to all cells of the attribute matrix so that the representative sample of nodes is generated from at least a subset of the nodes associated to the cells of the attribute matrix.

26. The instrumentation system according to claim 25, wherein the attributes of the attribute matrix are key attributes for which the representative sample of nodes is to be representative.

27. The instrumentation system according to claim 25, wherein the maximum number of nodes associated to each cell is based upon an estimated percentage of nodes in the decentralized network having the attribute value of the cell.

28. The instrumentation system according to claim 25, wherein nodes selected for associating with the cells of the attribute matrix are selected by crawling the network topology starting from an initially selected node.

29. A method for identifying a representative sample of nodes in a decentralized network, comprising:
indexing a sample of nodes in a decentralized network;
building a set of observed values for one searchable attribute found in all nodes in the sample;
drawing a sample of observed values for the one searchable attribute from the set;
performing a search in the decentralized network for nodes having at least one of the observed values for the one searchable attribute as in the drawn sample; and
generating a representative sample of nodes in the decentralized network by including at least a subset of nodes in the search results.

30. The method according to claim 29, wherein the indexing of the sample of nodes comprises: indexing a sample of connected nodes in the decentralized network.

31. The method according to claim 30, further comprising: generating the sample of connected nodes by identifying a node in the decentralized network, and identifying other nodes connected directly or indirectly to the identified node.

32. The method according to claim 31, wherein the identifying a node in the decentralized network comprises: connecting a node to the decentralized network and using that node as the identified node.

33. The method according to claim 29, wherein the one searchable attribute is independent of network topology.

34. The method according to claim 29, further comprising: using the representative sample of nodes to obtain an unbiased estimate of the distribution of other node attributes.

35. A method for identifying a representative sample of nodes in a decentralized network, comprising:
(a) identify a node in a decentralized network;
(b) determining if the node has an attribute value matching an attribute value of a cell of an attribute matrix;
(c) if the answer in (b) is NO, then jumping back to (a) to identify another node in the decentralized network, and if the answer to (b) is YES, then determining if the cell has reached its maximum number of associated nodes;
(d) if the answer in (c) is NO, then associating the node to the cell and jumping back to (b) to determine if the node has another attribute value matching that of another cell of the attribute matrix, and if the answer in (c) is YES, then determining if all cells in the attribute matrix have reached their maximum numbers of associated nodes; and
(e) if the answer in (d) is NO, then jumping back to (b) to determine whether the node has another attribute value matching that of another cell of the attribute matrix, and if the answer in (d) is YES, then generating a representative sample of nodes in the decentralized network from the nodes associated to the cells of the attribute matrix.

36. The method according to claim 35, wherein the attributes of the attribute matrix are key attributes for which the representative sample of nodes is to be representative.

37. The method according to claim 35, wherein the representative sample of nodes in the decentralized network is generated so as to include all of the nodes associated with the attribute matrix.

38. The method according to claim 35, wherein the maximum number of associated nodes for each cell in the attribute matrix is based upon an estimated percentage of nodes in the decentralized network having the attribute value of the cell.

39. The method according to claim 35, wherein each successively identified node in performing (a) is determined by crawling the network topology of the decentralized network starting with a first identified node.

40. The method according to claim 35, further comprising: using the representative sample of nodes to obtain an unbiased estimate of the distribution of other node attributes.

41. A method for estimating the number of nodes in a decentralized network, comprising:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

42. The method according to claim 41, wherein the reference network is a peer-to-peer file sharing network that keeps track of and provides information of the number of nodes currently connected to the network to each node currently connected to the network.

43. The method according to claim 41, wherein the counting of the number of nodes associated with the decentralized network that reside at addresses in the random sample, comprises: performing a low-level port scan for each of the addresses in the random sample, and inferring nodes associated with the decentralized network from the responses.

44. The method according to claim 41, wherein the counting of the number of nodes associated with the decentralized network that reside at addresses in the random sample, comprises: performing a high-level application scan for each port known to be used by a client software application associated with the decentralized network on each of the addresses in the random sample, and inferring nodes associated with the decentralized network from the responses.

45. The method according to claim 41, wherein the counting of the number of nodes associated with the decentralized network that reside at addresses in the random sample, comprises: hosting a client node connected to the decentralized network with at least one highly demanded file residing on the client node; recording IP addresses of other nodes in the decentralized network that attempt to communicate with the client node during a fixed period of time to download one or more of the at least one highly demanded file; and comparing the recorded IP addresses to the addresses in the random sample to identify nodes associated with the decentralized network.

46. A method for estimating the number of nodes in a decentralized network, comprising:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of nodes in the random sample; and
estimating the number of nodes in the decentralized network by multiplying the density of the decentralized network nodes by the size of the address space.

47. The method according to claim 46, wherein the counting of the number of nodes associated with the decentralized network that reside at addresses in the random sample, comprises: performing a low-level port scan for each of the addresses in the random sample, and inferring nodes associated with the decentralized network from the responses.

48. The method according to claim 46, wherein the counting of the number of nodes associated with the decentralized network that reside at addresses in the random sample, comprises: performing a high-level application scan for each port known to be used by a client software application associated with the decentralized network on each of the addresses in the random sample, and inferring nodes associated with the decentralized network from the responses.

49. The method according to claim 46, wherein the counting of the number of nodes associated with the decentralized network that reside at addresses in the random sample, comprises: hosting a client node connected to the decentralized network with at least one highly demanded file residing on the client node; recording IP addresses of other nodes in the decentralized network that attempt to communicate with the client node during a fixed period of time to download one or more of the at least one highly demanded file; and comparing the recorded IP addresses to the addresses in the random sample to identify nodes associated with the decentralized network.

50. A method for estimating the growth rate of a decentralized network, comprising:
estimating the number of nodes in the decentralized network at a point in time;
estimating the number of nodes in the decentralized network at a fixed period of time after the point in time; and
estimating the growth rate of the decentralized network by subtracting the estimated number of nodes in the decentralized network at the point in time by the estimated number of nodes in the decentralized network at the fixed period of time after the point in time, and dividing the difference by the fixed period of time.

51. The method according to claim 50, wherein the estimating the number of nodes in the decentralized network at a point in time comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

52. The method according to claim 50, wherein the estimating the number of nodes in the decentralized network at a point in time comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

53. A method for estimating acceleration in a growth of the number of nodes in a decentralized network, comprising:
generating a first estimate of the number of nodes in the decentralized network at a time t0;
generating a second estimate of the number of nodes in the decentralized network at a time (t0+Δt), where Δt is a time period;
generating a third estimate of the number of nodes in the decentralized network at a time (t0+2·Δt), where 2·Δt is twice the time period; and
estimating acceleration in the growth of the number of nodes in the decentralized network by generating a product by doubling the second estimate, generating a difference by subtracting the first and the third estimates from the product, and dividing the difference by the time period Δt.

54. The method according to claim 53, wherein the generating of the first estimate comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

55. The method according to claim 53, wherein the generating of the first estimate comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

56. The method according to claim 53, wherein the generating of the second estimate comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

57. The method according to claim 53, wherein the generating of the second estimate comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

58. The method according to claim 53, wherein the generating of the third estimate comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

59. The method according to claim 53, wherein the generating of the third estimate comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

60. A method for estimating the number of instances of a file in a decentralized network, comprising:
identifying a representative sample of nodes in a decentralized network;
determining a density of instances of a file in the representative sample of nodes; and
estimating the number of instances of the file in the decentralized network by multiplying the density of instances of the file by the number of nodes in the decentralized network.

61. The method according to claim 60, wherein the identifying of a representative sample of nodes comprises:
indexing a sample of nodes in a decentralized network;
building a set of observed values for one searchable attribute found in all nodes in the sample;
drawing a sample of observed values for the one searchable attribute from the set;
performing a search in the decentralized network for nodes having at least one of the observed values for the one searchable attribute as in the drawn sample; and
generating a representative sample of nodes in the decentralized network by including at least a subset of nodes in the search results.

62. The method according to claim 60, wherein the identifying of a representative sample of nodes comprises:
(a) identify a node in a decentralized network;
(b) determining if the node has an attribute value matching an attribute value of a cell of an attribute matrix;
(c) if the answer in (b) is NO, then jumping back to (a) to identify another node in the decentralized network, and if the answer to (b) is YES, then determining if the cell has reached its maximum number of associated nodes;
(d) if the answer in (c) is NO, then associating the node to the cell and jumping back to (b) to determine if the node has another attribute value matching that of another cell of the attribute matrix, and if the answer in (c) is YES, then determining if all cells in the attribute matrix have reached their maximum numbers of associated nodes; and
(e) if the answer in (d) is NO, then jumping back to (b) to determine whether the node has another attribute value matching that of another cell of the attribute matrix, and if the answer in (d) is YES, then generating a representative sample of nodes in the decentralized network from the nodes associated to the cells of the attribute matrix.

63. The method according to claim 60, wherein the determining of the density of instances of a file comprises:
generating a count by counting the number of copies of the file residing on the representative sample of nodes; and
calculating the density of instances of the file by dividing the count by the number of nodes in the representative sample of nodes.

64. The method according to claim 60, wherein the determining of the density of instances of a file comprises:
determining a globally unique identifier for the file by querying the decentralized network for the file;
generating a count by counting the number of occurrences of the globally unique identifier among all nodes in the representative sample of nodes; and
calculating the density of instances of the file by dividing the count by the number of nodes in the representative sample of nodes.

65. The method according to claim 60, wherein the determining of the density of instances of a file comprises:
computing one-way hash values for all files residing on the representative sample of nodes;
generating a count by counting the number of times that a one-way hash value for the file occurs among the computed one-way hash values for all files residing on the representative sample of nodes; and
calculating the density of instances of the file by dividing the count by the number of nodes in the representative sample of nodes.

66. The method according to claim 60, further comprising: estimating the number of nodes in the decentralized network if the actual number of nodes in the decentralized network is not known.

67. The method according to claim 66, wherein the estimating of the number of nodes in the decentralized network comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

68. The method according to claim 66, wherein the estimating of the number of nodes in the decentralized network comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

69. A method for estimating the rate of propagation of a file in a decentralized file network, comprising:
estimating the number of instances of a file in a decentralized network at a point in time;
estimating the number of instances of the file in the decentralized network at a fixed period of time after the point in time; and
estimating the rate of propagation of the file in the decentralized network by generating a difference by subtracting the estimated number of instances of the file in the decentralized network at the point in time from the estimated number of instances of the file in the decentralized network at the fixed period of time after the point in time, and dividing the difference by the fixed period of time.

70. The method according to claim 69, wherein the estimating of the number of instances of a file in a decentralized network at a point in time comprises:
identifying a representative sample of nodes in a decentralized network;
determining a density of instances of a file in the representative sample of nodes; and
estimating the number of instances of the file in the decentralized network by multiplying the density of instances of the file by the number of nodes in the decentralized network.

71. The method according to claim 69, wherein the estimating of the number of instances of a file in a decentralized network at the fixed period of time after the point in time comprises:
identifying a representative sample of nodes in a decentralized network;
determining a density of instances of a file in the representative sample of nodes; and
estimating the number of instances of the file in the decentralized network by multiplying the density of instances of the file by the number of nodes in the decentralized network.

72. A method for estimating acceleration of the propagation of a file in a decentralized network, comprising:
generating a first estimate of the rate of propagation of a file in a decentralized file network at a time t0;
generating a second estimate of the rate of propagation of the file in the decentralized file network at a time (t0+Δt), where Δt is a time period;
generating a third estimate of the rate of propagation of the file in the decentralized file network at a time (t0+2·Δt), where 2·Δt is twice the time period; and
estimating acceleration of the propagation of the file in the decentralized network by generating a product by doubling the second estimate, generating a difference by subtracting the first and the third estimates from the second estimate, and dividing the difference by the time period Δt.

73. The method according to claim 72, wherein the generating of the first estimate comprises:
estimating the number of instances of a file in a decentralized network at a point in time;
estimating the number of instances of the file in the decentralized network at a fixed period of time after the point in time; and
estimating the rate of propagation of the file in the decentralized network by generating a difference by subtracting the estimated number of instances of the file in the decentralized network at the point in time from the estimated number of instances of the file in the decentralized network at the fixed period of time after the point in time, and dividing the difference by the fixed period of time.

74. The method according to claim 72, wherein the generating of the second estimate comprises:
estimating the number of instances of a file in a decentralized network at a point in time;
estimating the number of instances of the file in the decentralized network at a fixed period of time after the point in time; and
estimating the rate of propagation of the file in the decentralized network by generating a difference by subtracting the estimated number of instances of the file in the decentralized network at the point in time from the estimated number of instances of the file in the decentralized network at the fixed period of time after the point in time, and dividing the difference by the fixed period of time.

75. The method according to claim 72, wherein the generation of the third estimate comprises:
estimating the number of instances of a file in a decentralized network at a point in time;
estimating the number of instances of the file in the decentralized network at a fixed period of time after the point in time; and
estimating the rate of propagation of the file in the decentralized network by generating a difference by subtracting the estimated number of instances of the file in the decentralized network at the point in time from the estimated number of instances of the file in the decentralized network at the fixed period of time after the point in time, and dividing the difference by the fixed period of time.

76. A method for uniformly infiltrating a decentralized network with software agents masquerading as nodes of the decentralized network, comprising:
identifying a representative sample of nodes in a decentralized network; and
attaching a corresponding software agent masquerading as a node to each of the nodes in the representative sample of nodes.

77. The method according to claim 76, wherein the identifying of a representative sample of nodes comprises:
indexing a sample of nodes in a decentralized network;
building a set of observed values for one searchable attribute found in all nodes in the sample;
drawing a sample of observed values for the one searchable attribute from the set;
performing a search in the decentralized network for nodes having at least one of the observed values for the one searchable attribute as in the drawn sample; and
generating a representative sample of nodes in the decentralized network by including at least a subset of nodes in the search results.

78. The method according to claim 76, wherein the identifying of a representative sample of nodes comprises:
(a) identify a node in a decentralized network;
(b) determining if the node has an attribute value matching an attribute value of a cell of an attribute matrix;
(c) if the answer in (b) is NO, then jumping back to (a) to identify another node in the decentralized network, and if the answer to (b) is YES, then determining if the cell has reached its maximum number of associated nodes;
(d) if the answer in (c) is NO, then associating the node to the cell and jumping back to (b) to determine if the node has another attribute value matching that of another cell of the attribute matrix, and if the answer in (c) is YES, then determining if all cells in the attribute matrix have reached their maximum numbers of associated nodes; and
(e) if the answer in (d) is NO, then jumping back to (b) to determine whether the node has another attribute value matching that of another cell of the attribute matrix, and if the answer in (d) is YES, then generating a representative sample of nodes in the decentralized network from the nodes associated to the cells of the attribute matrix.

79. A method for uniformly distributing files in a decentralized network, comprising:
uniformly infiltrating a decentralized network with software agents masquerading as nodes of the decentralized network; and
uploading a file to each of the software agents.

80. The method according to claim 79, wherein the uniformly infiltrating of the decentralized network with software agents comprises:
identifying a representative sample of nodes in a decentralized network; and
attaching a corresponding software agent masquerading as a node to each of the nodes in the representative sample of nodes.

81. A method for estimating a total number of search queries in a decentralized network over a specified period of time, comprising:
uniformly infiltrating a decentralized network with software agents masquerading as nodes in the decentralized network;
causing the software agents to record all received search queries for a specified period of time; and
estimating a total number of search queries in the decentralized network for the specified period of time by generating a sum by adding the received search queries recorded by the software agents during the specified period of time, generating a product by multiplying the sum by the number of nodes in the decentralized network, and dividing the product by the number of the software agents.

82. The method according to claim 81, wherein the uniformly infiltrating of the decentralized network with software agents comprises:
identifying a representative sample of nodes in a decentralized network; and
attaching a corresponding software agent masquerading as a node to each of the nodes in the representative sample of nodes.

83. The method according to claim 81, further comprising: estimating the number of nodes in the decentralized network if the actual number of nodes in the decentralized network is unknown.

84. The method according to claim 83, wherein the estimating of the number of nodes in the decentralized network comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

85. The method according to claim 83, wherein the estimating of the number of nodes in the decentralized network comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

86. A method for estimating a total number of search queries for a file in a decentralized network over a specified period of time, comprising:
uniformly infiltrating a decentralized network with software agents masquerading as nodes in the decentralized network;
causing the software agents to record all received search queries for a file during a specified period of time; and
estimating a total number of search queries for the file in the decentralized network for the specified period of time by generating a sum by adding the received search queries for the file recorded by the software agents during the specified period of time, generating a product by multiplying the sum by the number of nodes in the decentralized network, and dividing the product by the number of the software agents.

87. The method according to claim 86, wherein the uniformly infiltrating of the decentralized network with software agents comprises:
identifying a representative sample of nodes in a decentralized network; and
attaching a corresponding software agent masquerading as a node to each of the nodes in the representative sample of nodes.

88. The method according to claim 86, further comprising: estimating the number of nodes in the decentralized network if the actual number of nodes in the decentralized network is unknown.

89. The method according to claim 88, wherein the estimating of the number of nodes in the decentralized network comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

90. The method according to claim 88, wherein the estimating of the number of nodes in the decentralized network comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

91. A method for estimating a total number of downloads of a file in a decentralized network over a specified period of time, comprising:
uniformly infiltrating a decentralized network with software agents masquerading as nodes in the decentralized network;
uploading copies of a file to each of the software agents;
causing the software agents to respond to each request to download a copy of the file over a specified period of time, and keep a record of each download;
determining the aggregate number of downloads of copies of the file over the specified period of time by all the software agents; and
estimating a total number of downloads of the file in the decentralized network over the specified period of time by generating a product by multiplying the aggregate number of downloads of copies of the file over the specified period of time by all the software agents by the number of nodes in the decentralized network, and dividing the product by the number of software agents.

92. The method according to claim 91, further comprising: estimating the number of nodes in the decentralized network if the actual number of nodes in the decentralized network is not known.

93. The method according to claim 92, wherein the estimating of the number of nodes in the decentralized network comprises:
drawing a random sample of all potential addresses in an underlying address space common to a decentralized network and a reference network;
counting the number of nodes associated with the decentralized network that reside at addresses in the random sample;
calculating a density of the decentralized network nodes by dividing the count of nodes associated with the decentralized network by the number of addresses in the random sample;
counting the number of nodes associated with a reference network that reside at addresses in the random sample;
calculating a density of the reference network nodes by dividing the count of nodes associated with the reference network by the number of addresses in the random sample; and
estimating the number of nodes in the decentralized network by multiplying the density of the decentralized network nodes with a known number of nodes in the reference network, and dividing the product by the density of the reference network nodes.

94. The method according to claim 92, wherein the estimating of the number of nodes in the decentralized network comprises:
drawing a random sample of all potential addresses in an underlying address space;
counting the number of nodes associated with the decentralized network that reside at addresses in the random sample;
calculating a density of the decentralized network nodes by dividing the count of nodes associated with the decentralized network by the number of addresses in the random sample; and
estimating the number of nodes in the decentralized network by multiplying the density of the decentralized network nodes by the size of the address space.

95. The method according to claim 91, wherein the uniformly infiltrating of the decentralized network with software agents comprises:
identifying a representative sample of nodes in a decentralized network; and
attaching a corresponding software agent masquerading as a node to each of the nodes in the representative sample of nodes.

96. The method according to claim 91, wherein the file is a decoy file spoofing another file that is the target of the download requests, and the method estimates the number of downloads of the target file during the specified period of time in the decentralized network.
